(19) United States
(12) Patent Application Publication
(10) Pub. No.: US 2019/0371023 A1
(43) Pub. Date: Dec. 5, 2019

(54) METHOD AND APPARATUS FOR GENERATING MULTIMEDIA CONTENT, AND DEVICE THEREFOR

(71) Applicant: UCWEB SINGAPORE PTE. LTD., Singapore (SG)

(72) Inventors: Zhihang ZHU, Beijing (CN); Yuepeng HU, Beijing (CN); Yinghu YUAN, Beijing (CN); Junjie MA, Beijing (CN); Lulu PAN, Beijing (CN); Qianqian ZHANG, Beijing (CN)

(21) Appl. No.: 16/138,906

(22) Filed: Sep. 21, 2018

Related U.S. Application Data
(63) Continuation of application No. PCT/CN2018/089360, filed on May 31, 2018.

(51) Int. Cl. G06T 11/60; G06F 17/27

(52) U.S. Cl. CPC G06T 11/60; G06F 17/2705

(57) ABSTRACT

A method and apparatus for generating multimedia content, and a device therefor are provided. The method includes: acquiring reading object data of multimedia content to be generated; parsing the reading object data to acquire feature information of the reading object data; determining multimedia content profile information matching the feature information; and generating multimedia content corresponding to the reading object data according to the multimedia content profile information and the reading object data. According to the embodiments of the present application, content exhibition forms in the electronic reading manner are greatly enriched, user's reading experience is improved, and customized requirements of the user are effectively satisfied.

### CROSS-REFERENCE TO RELATED DISCLOSURES

The present disclosure is a continuation of international disclosure No. PCT/CN2018/089360 filed on May 31, 2018, which is hereby incorporated by reference in its entirety.

### TECHNICAL FIELD

Embodiments of the present disclosure relate to the technical field of Internet, and in particular, relate to a method and apparatus for generating multimedia content, and a device/terminal/server therefor.

### BACKGROUND

With the development of the Internet technologies, traditional paper-based reading has been gradually replaced by electronic reading. People more and more tend to use the Internet and computer technologies to practice electronic reading by using various devices/terminals/servers.

However, the current electronic reading manner is limited to text exhibition, or text-picture exhibition. For example, texts and/or pictures are exhibited via browser webpages or electronic book disclosures.

Accordingly, in the current electronic reading manner, content exhibition is singular, and customized requirements of a user in electronic reading fail to be satisfied.

### SUMMARY

Embodiments of the present disclosure provide a method and apparatus for generating multimedia content, and a device/terminal/server therefor, to solve the problem that content exhibition in an electronic reading manner is singular and thus customized requirements of a user fail to be satisfied in the prior art.

According to one aspect of embodiments of the present disclosure, a method for generating multimedia content is provided. The method includes: acquiring reading object data of multimedia content to be generated; parsing the reading object data to acquire feature information of the reading object data; determining multimedia content profile information matching the feature information; and generating multimedia content corresponding to the reading object data according to the multimedia content profile information and the reading object data.

According to another aspect of embodiments of the present disclosure, an apparatus for generating multimedia content is provided. The apparatus includes: a first acquiring module, configured to reading object data of multimedia content to be generated; a second acquiring module, configured to parse the reading object data to acquire feature information of the reading object data; a determining module, configured to determine multimedia content profile information matching the feature information; and a generating module, configured to generate multimedia content corresponding to the reading object data according to the multimedia content profile information and the reading object data.

According to still another aspect of embodiments of the present disclosure, a device/terminal/server is further provided. The device/terminal/server includes: one or more processors; and a storage device, configured to store one or more programs; where the one or more programs, when being executed by the one or more processors, cause the one or more processors to perform the method as described above.

According to yet still another aspect of embodiments of the present disclosure, a computer-readable storage medium is further provided. The computer-readable storage medium stores a computer program; wherein the computer program, when being executed by a processor, causes the processor to perform the method as described above.

In the technical solutions according to embodiments of the present disclosure, the multimedia content profile information matching the feature information is determined according to the feature information of the reading object data, such that the corresponding multimedia content is generated according to the multimedia content profile information and the reading object data. The multimedia content profile information is configured to generate multimedia content having a specific mode or subject or style. According to the embodiment of the present disclosure, when a user reads the multimedia content in the electronic reading manner, the texts and/or pictures and the like static content are not only read, but also the dynamic multimedia content is watched. This greatly enriches content exhibition forms in the electronic reading manner, improves user's reading experience, and effectively satisfies customized requirements of the user.

### BRIEF DESCRIPTION OF THE DRAWINGS

FIG. 1 is a flowchart illustrating steps of a method for generating multimedia content according to the first embodiment of the present disclosure;

FIG. 2 is a flowchart illustrating steps of a method for generating multimedia content according to the second embodiment of the present disclosure;

FIG. 3 is a schematic diagram of an exhibition interface of the multimedia content according to the embodiment as illustrated in FIG. 2;

FIG. 4 is a schematic diagram of another exhibition interface of the multimedia content according to the embodiment as illustrated in FIG. 2;

FIG. 5 is a schematic structural diagram of an apparatus for generating multimedia content according to the third embodiment of the present disclosure;

FIG. 6 is a schematic structural diagram of an apparatus for generating multimedia content according to the fourth embodiment of the present disclosure; and

FIG. 7 is a schematic structural diagram of a device/terminal/server according to the fifth embodiment of the present disclosure.

### DETAILED DESCRIPTION

The specific embodiments of the present disclosure are further described in detail with reference to the accompanying drawings (in the several drawings, like reference numerals denote like elements). The following embodiments are merely intended to illustrate the present disclosure, but are not intended to limit the scope of the present disclosure.

A person skilled in the art may understand that the terms “first”, “second” and the like in the embodiments of the present disclosure are only used to distinguish different steps, devices or modules or the like, and do not denote any specific technical meaning or necessary logical sequence therebetween.

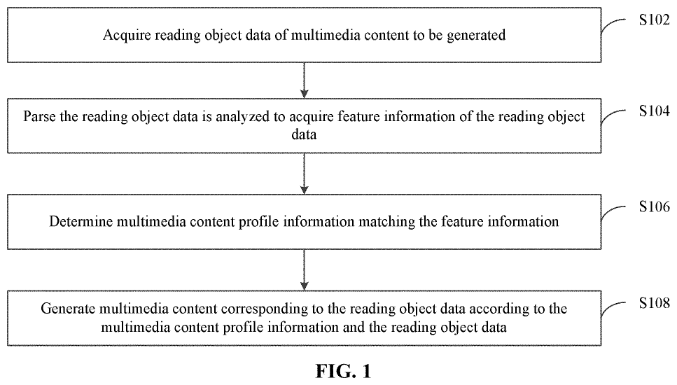

Referring to FIG. 1, a flowchart illustrating steps of a method for generating multimedia content according to the first embodiment of the present disclosure is given.

The method for generating multimedia content according to this embodiment includes the following steps:

Step S102: Reading object data of multimedia content to be generated is acquired.

The reading object data includes, but not limited to: data that may be read in an electronic reading manner, for example, texts, pictures or the like; the generated multimedia content may include, but not limited to: one or more (two or more than two) of a dynamic image, an audio, a video, an AR and a special effect.

Step S104: The reading object data is parsed to acquire feature information of the reading object data.

The feature information of the reading object data is used to indicate features of the reading object data. For example, with respect to textual data, the feature information may be a plurality of keywords or segmented words thereof; and with respect to picture data, the feature information may be information of feature points of a picture, or the like.

In the embodiment of the present disclosure, a person skilled in the art may parse the reading object data in any suitable manner, to acquire the feature information thereof, for example, a natural language processing manner, a support vector machine manner, a neural network manner or the like, which is not limited in the embodiment of the present disclosure.

Step S106: Multimedia content profile information matching the feature information is determined.

The multimedia content profile information matching the feature information may be determined according to the feature information of the reading object data. A person skilled in the art may determine, in any suitable manner, whether the feature information matches the multimedia content profile information. Optionally, the multimedia content profile information may also correspond to corresponding feature information or keyword information, to determine a matching degree between the multimedia content profile information and the feature information of the reading object data.

The multimedia content profile information is used to provide information of a photographing profile observing a specific rule, to generate multimedia content having a corresponding subject or style or mode, for example, various magic expression profiles, various scenarios or script profiles or the like. In addition to the specific rule, optionally, the multimedia content profile information may further include at least one of a predetermined text, image, audio and video.

The multimedia content profile information may be locally stored and/or stored in a server. If the multimedia content profile information is locally stored, in the subsequent steps, the stored profile information may be directly used. If the multimedia content profile information is stored in the server, the profile information may be loaded from the server and stored locally for use. If the multimedia content profile information is locally stored, the use of the profile information is convenient. If the multimedia content profile information is stored in the server, the profile information may be acquired from the server where necessary. In this way, local storage resources and system consumptions are reduced.

Step S108: Multimedia content corresponding to the reading object data is generated according to the multimedia content profile information and the reading object data.

After the multimedia content profile information is determined, a portion of or all of the reading object data may be used to generate the content desired by the profile information, and the content may be combined with the content corresponding to the profile information to generate final multimedia content corresponding to the reading object data.

In this embodiment, the multimedia content profile information matching the feature information is determined according to the feature information of the reading object data, such that the corresponding multimedia content is generated according to the multimedia content profile information and the reading object data. The multimedia content profile information is configured to generate multimedia content having a specific mode or subject or style. According to the embodiment of the present disclosure, when a user reads the multimedia content in the electronic reading manner, the texts and/or pictures and the like static content are not only read, but also the dynamic multimedia content is watched. This greatly enriches content exhibition forms in the electronic reading manner, improves user's reading experience, and effectively satisfies customized requirements of the user.

The method for generating multimedia content according to this embodiment may be performed by any device having the data processing capability, including, but not limited to: various terminal devices or servers, for example, PCs, tablet computers, mobile terminals or the like.

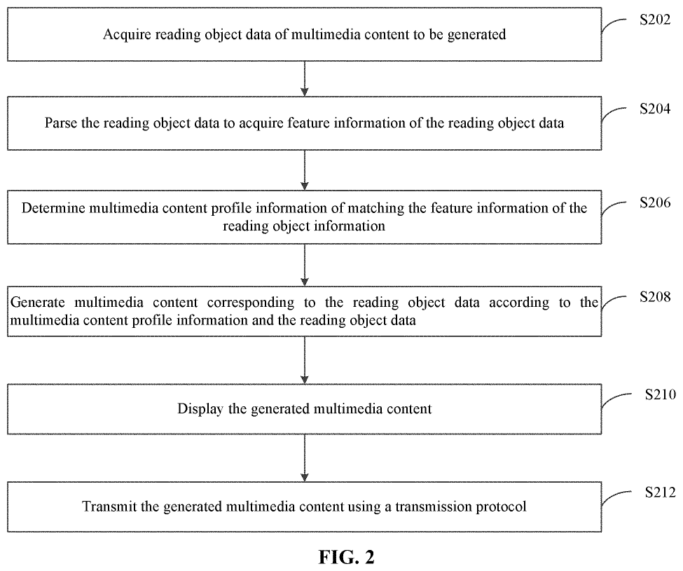

Referring to FIG. 2, a flowchart illustrating steps of a method for generating multimedia content according to the second embodiment of the present disclosure is given.

The method for generating multimedia content according to this embodiment includes the following steps:

Step S202: Reading object data of multimedia content to be generated is acquired.

As described above, the reading object data includes, but not limited to: data that may be read in an electronic reading manner, for example, texts, pictures or the like; the generated multimedia content may include, but not limited to: one or more (two or more than two) of a dynamic image, an audio, a video, an AR and a special effect.

Step S204: The reading object data is parsed to acquire feature information of the reading object data.

A person skilled in the art may parse the reading object data in any suitable manner, to acquire the feature information thereof.

Step S206: Multimedia content profile information of matching the feature information of the reading object information is determined.

As described in the first embodiment, the multimedia content profile information is used to provide the information of the photographing profile observing the specific rule, to generate the multimedia content having the corresponding subject, style or mode. Optionally, the multimedia content profile information may include: feature information and editing information of photographing the multimedia content.

The feature information indicates the feature of the photographing profile of the multimedia content. Optionally, the feature information may include at least one of: expression information, action information, audio information, color information and scenario information. For example, the expression information includes disclosure software and/or expression content for the user to photograph and/or edit magic expressions; the action information includes disclosure software and/or action content for the user to photograph and/or edit magic actions; the script information includes disclosure software and/or script content for the user to photograph and/or edit videos; the audio information includes disclosure software and/or audio content for the user to photograph and/or edit audios; the color information includes disclosure software and/or color content for the user to photograph and/or edit videos; and the scenario information includes disclosure software and/or scenario content for the user to photograph and/or edit videos.

The editing information indicates information of editing the multimedia content by the photographing profile using the multimedia content. Optionally, the editing information may include: information of an disclosure that generates the multimedia content. For example, the editing information may include a photographing disclosure and/or editing disclosure of the multimedia content; optionally, the editing information may further include another similar disclosure that implements photographing and/or editing besides the photographing disclosure and/or editing disclosure of the multimedia content; and further optionally, the editing information may further include a photographing and/or editing means of the multimedia content, for example, exposure duration, aperture selection, color adjustment, personage and space allocation, photographing angle, light selection, personage action or the like.

The multimedia content profile information may be acquired based on the above feature information and editing information. With respect to the manner of receiving the multimedia content, local multimedia content may be generated according to the acquired profile information, or elements of the received multimedia content or the multimedia content to be generated may be edited according to the profile information, or elements of the multimedia content to be generated may be firstly photographed according to the acquired profile information and then the elements may be correspondingly edited according to the profile information, or the profile information may be firstly edited and then elements of the multimedia content to be generated are edited, and finally the local multimedia content may be generated. In this way, it is unnecessary for the user for generating the multimedia content to download and/or install a corresponding program or disclosure for generating the multimedia content, which mitigates load of the user, and improves the efficiencies of generating, interacting and sharing the multimedia content.

For example, a multimedia content receiving party parses the transmission protocol to acquire the profile information corresponding to the magic expression video, for example, including information of the photographing disclosure and photographing means for generating the magic expression video, and expression content. The multimedia content receiving party is capable of logging in to the server according to the profile information to photograph the same magic expression video by using the photographing means without installing the photographing and/or editing disclosure. Further, the photographed magic expression video may also be shared to other users. Nevertheless, the other users may also select to download the disclosure for photographing and/or editing the magic expression to the local to implement photographing and/or editing of the magic expression video.

Still for example, the multimedia content receiving party parses the transmission protocol to acquire the profile information corresponding to the script video, for example, including information of the photographing disclosure and photographing means for generating the script video, and script content. The multimedia content receiving party is capable of logging in to the server according to the profile information to photograph the same video by using the photographing means according to the script without installing the photographing and/or editing disclosure. Further, the photographed video may also be shared to other users. Nevertheless, the other users may also select to download the disclosure for photographing and/or editing to the local to implement photographing and/or editing of the video.

Step S208: Multimedia content corresponding to the reading object data is generated according to the multimedia content profile information and the reading object data.

The generated multimedia content may include, but not limited to: one or more (two or more than two) of a dynamic image, an audio, a video, an AR and a special effect.

After the multimedia content profile information is determined, data for generating the multimedia content may be acquired from the reading object data according to the profile information, and thus the multimedia content may be generated according to a combination of the multimedia content profile information and the acquired data. For example, the reading object data may be read according to the audio information in the profile information to implement acoustic reading; still for example, description of the expression or action of a personage in the reading object data may be acquired, and a corresponding magic expression and/or magic action may be generated by using the expression information and/or action information in the profile information according to the description; and still for example, a scene short video or the like may be generated in combination of the reading object data according to at least one of the script information, color information and scenario information in the profile information.

In one possible implementation, when this step is being performed, multimedia content generation condition data corresponding to the multimedia content profile information may be acquired from reading object data; and the multimedia content corresponding to the reading object data may be generated according to the multimedia content generation condition data and the multimedia content profile information. For example, when the magic expression and/or action is being generated, the magic expression and/or action may be generated according to the description of the expression and/or action in the reading object data. That is, with respect to the multimedia content profile information, desired data may be screened out from the reading object data, that is, the multimedia content generation condition data, and thus the multimedia content may be generated according to a combination of the data and the profile information.

In another possible implementation, before the multimedia content corresponding to the reading object data is generated according to the multimedia content profile information and the reading object data in this step, the input multimedia content generation parameter may be received. For example, the user defines the input multimedia content generation parameter via the interface, which includes, but not limited to: a personage (including a real personage or a virtual personage) parameter, a gender parameter, a scenario parameter, and other parameters or the like that are defined by a person skilled in the art according to the actual needs.

Based on this, when generating multimedia content corresponding to the reading object data according to the multimedia content profile information and the reading object data, the multimedia content corresponding to the reading object data may be generated according to the multimedia content profile information, the reading object data and the multimedia content generation parameter. For example, when a scenario video is being generated according to the scenario information in the multimedia content profile information, if the user selects or inputs the name of a specific personage (for example, a famous actor or actress), a virtual image of the specific personage may be acquired, and the corresponding scenario video may be generated based on a combination of the virtual image and the profile information; still for example, when an audio reading object is being generated according to the audio information in the multimedia content profile information, if the user selects or inputs the name of a specific personage (for example, a famous reader), a real voice or synthesized voice of the specific personage may be acquired, and the corresponding audio reading object may be generated based on a combination of the voice and the profile information; and still for example, when a scenario video is being generated according to the scrip information and/or scenario information in the multimedia content profile information, if the user selects or inputs a scenario parameter, for example, “seaside”, the generated scenario video uses the seaside as the scenario, or the like. With the multimedia content generation parameter, a higher multimedia content participation degree is provided for the user, and the user may select elements for generating the multimedia content according to preferences thereof, which improves the user experience.

Step S201: The generated multimedia content is displayed.

The multimedia content includes, but not limited to: multimedia content generated by busing a floating window; or reading object data displayed in the first region of the display screen and multimedia content displayed in the second region of the display screen (for example, the reading object data and the multimedia content data are displayed in a split-screen manner on the display screen, or other suitable content or data may be displayed while the reading object data and the multimedia content are displayed).

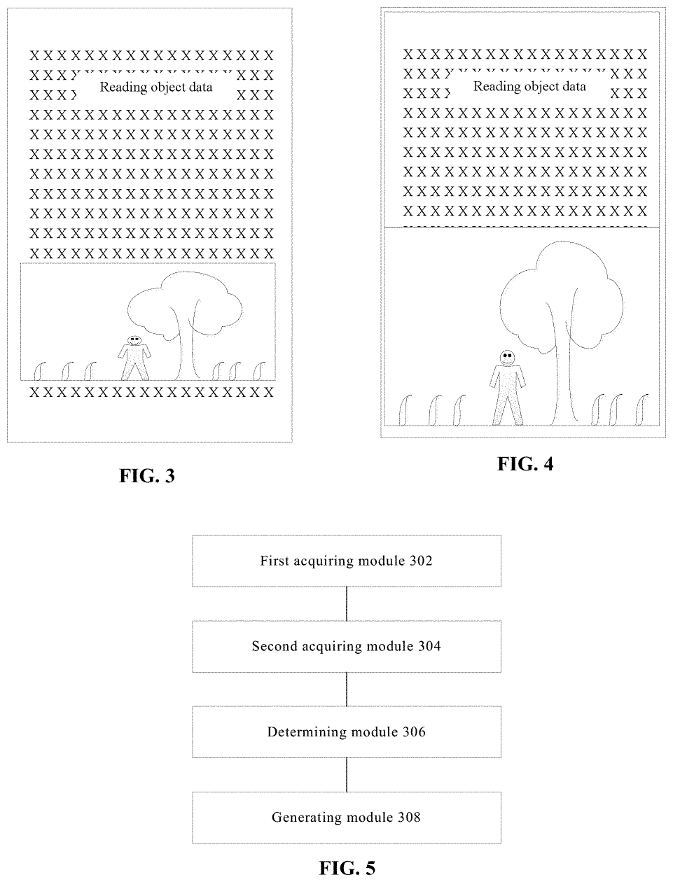

FIG. 3 illustrates an interface of the multimedia content displayed in the floating window manner. As illustrated in FIG. 3, the floating window floats over the reading object data, and routine floating window operations, for example, dragging, size adjusting, hiding, closing or the like may be performed. The content displayed in the floating window is a frame of pictures in a short video generated according to the reading object data and the multimedia content profile information. The display in the floating window manner is flexible, which facilitates adjustment of the display window by the user.

FIG. 4 illustrates an interface of the multimedia content displayed in the split-screen manner. As illustrated in FIG. 4, the reading object data is displayed on the upper half screen of the display screen, and the multimedia content is displayed on the lower half screen of the display screen. The multimedia content on the lower half screen is a frame of pictures in a short video generated according to the reading object data and the multimedia content profile information. By displaying data in different regions of the display screen, a larger multimedia content display space may be achieved, and the displayed data may be viewed or checked with a comparison against the reading object data, which improves the reading experience.

Nevertheless, the data display is not limited to the above display manners. In practical disclosure, a person skilled in the art may further employ any suitable manner to display the generated multimedia content, for example, a full-screen display manner or the like.

Step S212: The generated multimedia content is transmitted using a transmission protocol.

For example, the generated multimedia content is transmitted to other users in a specific range or non-specific range using the transmission protocol for sharing.

The transmission protocol carries the multimedia content profile information. The multimedia content profile information is carried in the transmission protocol. The multimedia content receiving party may acquire the corresponding profile information without installing the disclosure software for generating the multimedia content, such that local multimedia content matching or corresponding to the received multimedia content may be generated according to the user's operations. In this way, effective information interaction between the users is implemented while the operation load of the multimedia content receiving party is mitigated.

The transmission protocol that carries the profile information may be any suitable protocol, including, but not limited to, the HTTP protocol. For example, a multimedia content sending party codes the multimedia content profile information, for example, coding “magic expression: A”, “facial treatment: enable”, and “music: X” respectively, and carrying the coding information in the HTTP protocol. The multimedia content receiving party parses the transmission protocol to acquire the coding information therein, hence acquire the corresponding profile information from the corresponding server according to the coding information, and finally, performs corresponding operations according to the profile information. The specific coding rule and manner may be implemented in any suitable manner by a person skilled in the art according to the actual needs and the requirements of the used transmission protocol, which is not limited in the embodiment of the present disclosure.

For example, the multimedia content receiving party may acquire the feature information of photographing the multimedia content and the editing information thereof by parsing the transmission protocol used by the received multimedia content, and acquire the multimedia content profile information according to the feature information and the editing information. Hence, the multimedia content receiving party may generate similar or matched multimedia content according to the reading object data and the acquired profile information where necessary.

It should be noted that this step is an optional step, and in practical disclosure, a person skilled in the art may share the generated multimedia content and the multimedia content profile information to the others in any other suitable manner.

In this embodiment, the multimedia content profile information matching the feature information is determined according to the feature information of the reading object data, such that the corresponding multimedia content is generated according to the multimedia content profile information and the reading object data. The multimedia content profile information is configured to generate multimedia content having a specific mode or subject or style. According to the embodiment of the present disclosure, when a user reads the multimedia content in the electronic reading manner, the texts and/or pictures and the like static content are not only read, but also the dynamic multimedia content is watched. This greatly enriches content exhibition forms in the electronic reading manner, improves user's reading experience, and effectively satisfies customized requirements of the user.

The method for generating multimedia content according to this embodiment may be performed by any device having the data processing capability, including, but not limited to: various terminal devices or servers, for example, PCs, tablet computers, mobile terminals or the like.

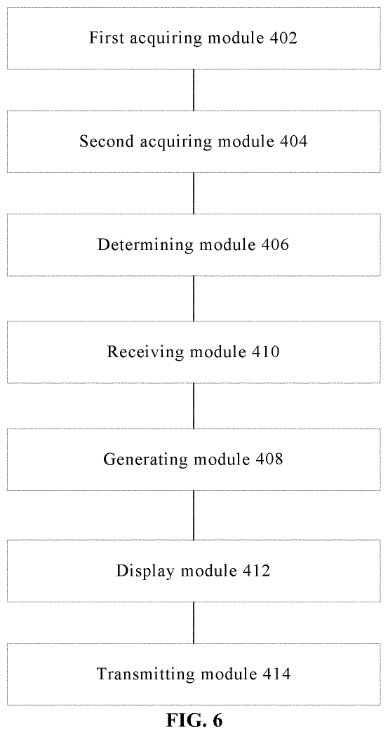

FIG. 5 is a schematic structural diagram of an apparatus for generating multimedia content according to a third embodiment of the present disclosure.

The apparatus for generating multimedia content of this embodiment includes: a first acquiring module 302 that is configured to read object data of multimedia content to be generated; a second acquiring module 304 that is configured to parse the reading object data to acquire feature information of the reading object data; a determining module 306 that is configured to determine multimedia content profile information matching the feature information; and a generating module 308 that is configured to generate multimedia content corresponding to the reading object data according to the multimedia content profile information and the reading object data.

The apparatus for generating multimedia content of the embodiment may be used to implement the corresponding methods for generating multimedia content which are described in the previous embodiments, and achieve similar technical benefits, which will not be repeated for brevity.

FIG. 6 is a schematic structural diagram of an apparatus for generating multimedia content according to a fourth embodiment of the present disclosure.

The apparatus for generating multimedia content of this embodiment includes: a first acquiring module 402 that is configured to reading object data of multimedia content to be generated; a second acquiring module 404 that is configured to parse the reading object data to acquire feature information of the reading object data; a determining module 406 that is configured to determine multimedia content profile information matching the feature information; and a generating module 408 that is configured to generate multimedia content corresponding to the reading object data based on the multimedia content profile information and the reading object data.

Optionally, the content profile information includes: feature information and editing information of photographed multimedia content.

Optionally, the feature information of the multimedia content comprises at least one of: expression information, action information, script information, audio information, color information, and scenario information.

Optionally, the editing information comprises: information of an disclosure that generates the multimedia content.

Optionally, the generating module 408 is configured to acquire multimedia content generation condition data corresponding to the multimedia content profile information from the reading object data; and generate the multimedia content corresponding to the reading object data according to the multimedia content generation condition data and the multimedia content profile information.

Optionally, the apparatus for generating multimedia content of this embodiment further includes a receiving module 410 that is configured to receive a multimedia content generation parameter before the generating module 408 generates multimedia content corresponding to the reading object data according to the multimedia content profile information and the reading object data. The generating module 408 is configured to generate the multimedia content corresponding to the reading object data according to the multimedia content profile information, the reading object data and the multimedia content generation parameter.

Optionally, the apparatus for generating multimedia content of this embodiment further includes a display module 412 that is configured to display the multimedia content in a floating window; or configured to display the reading object data in a first region of a display screen, and display the generated multimedia content in a second region of the display screen.

Optionally, the apparatus for generating multimedia content of this embodiment further includes a transmitting module 414 that is configured to transmit the generated multimedia content using a transmission protocol, wherein the transmission protocol carries the multimedia content profile information.

The apparatus for generating multimedia content of the embodiment may be used to implement the corresponding methods for generating multimedia content which are described in the previous embodiments, and achieve similar technical benefits, which will not be repeated for brevity.

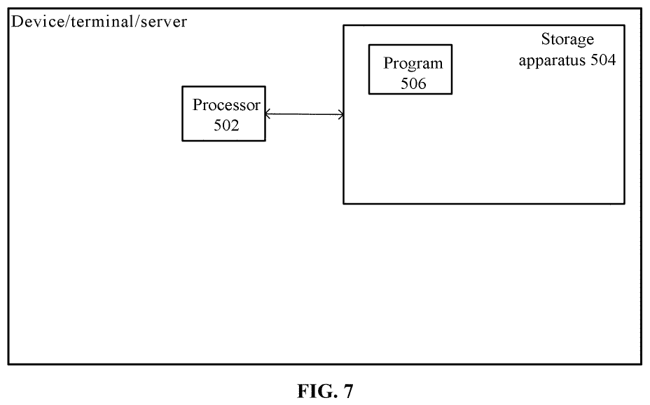

FIG. 7 is a schematic structural diagram of an apparatus for generating multimedia content according to a fifth embodiment of the present disclosure.

As illustrated in FIG. 7, the device/terminal/server may include: a processor 502, and a memory 504.

The processor 502 is configured to execute a program 506 to specifically perform the related steps in the methods for generating multimedia content.

Specifically, the program 506 may include a program code, wherein the program code includes a computer-executable instruction.

The processor 502 may be a central processing unit (CPU) or an Disclosure Specific Integrated Circuit (ASIC), or configured as one or more integrated circuits for implementing the embodiments of the present disclosure. The device/terminal/server includes one or more processors, which may be the same type of processors, for example, one or more CPUs, or may be different types of processors, for example, one or more CPUs and one or more ASICs.

The memory 504 is configured to store one or more programs 506. The memory 504 may include a high-speed RAM memory, or may also include a non-volatile memory, for example, at least one magnetic disk memory.

Specifically, the program 506 may drive the processor 502 to perform the following operations: acquire reading object data of multimedia content to be generated; parse the reading object data to acquire feature information of the reading object data; determine multimedia content profile information matching the feature information; and generate multimedia content corresponding to the reading object data according to the multimedia content profile information and the reading object data.

Optionally, the content profile information includes: feature information and editing information of photographed multimedia content.

Optionally, the feature information of the multimedia content comprises at least one of: expression information, action information, script information, audio information, color information, and scenario information.

Optionally, the editing information comprises: information of an disclosure that generates the multimedia content.

In another embodiment, when the program 506 drives the processor 502 to generate the multimedia content corresponding to the reading object data according to the multimedia content profile information and the reading object data, the program 506 may also drive the processor 502 to: acquire multimedia content generation condition data corresponding to the multimedia content profile information from the reading object data; and generate the multimedia content corresponding to the reading object data according to the multimedia content generation condition data and the multimedia content profile information.

In another embodiment, before the program 506 drives the processor 502 to generate the multimedia content corresponding to the reading object data according to the multimedia content profile information and the reading object data, the program 506 may also drive the processor 502 to: receive an input multimedia content generation parameter; and generate the multimedia content corresponding to the reading object data according to the multimedia content profile information, the reading object data and the multimedia content generation parameter.

In another embodiment, the program 506 drives the processor 502 to display the multimedia content in a floating window; or display the reading object data in a first region of a display screen, and displaying the generated multimedia content in a second region of the display screen.

In another embodiment, the program 506 drives the processor 502 to transmit the generated multimedia content using a transmission protocol. The transmission protocol carries the multimedia content profile information.

Specific practice of various steps in program 506 may be referenced to the description of related steps and units in the above embodiment illustrating the method for processing multimedia data. A person skilled in the art would clearly acknowledge that for ease and brevity of description, the specific operation processes of the above described devices and modules may be referenced to the relevant portions in the above described method embodiments, which are thus not described herein any further.

With the device/terminal/server, the multimedia content profile information matching the feature information is determined according to the feature information of the reading object data, such that the corresponding multimedia content is generated according to the multimedia content profile information and the reading object data. The multimedia content profile information is configured to generate multimedia content having a specific mode or subject or style. According to the embodiment of the present disclosure, when a user reads the multimedia content in the electronic reading manner, the texts and/or pictures and the like static content are not only read, but also the dynamic multimedia content is watched. This greatly enriches content exhibition forms in the electronic reading manner, improves user's reading experience, and effectively satisfies customized requirements of the user.

It should be noted that the devices/steps in the embodiments described above may be separated more devices/steps based on needs in implementing the embodiments. Two or more of the devices/steps described above may be recombined into new forms of devices/steps to achieve the object of this disclosure. Particularly, according to the embodiment of the present disclosure, the processes described above with reference to the flowcharts may be practiced as a computer software program. For example, an embodiment of the present disclosure provides a product of a computer program which includes a computer program borne on a computer-readable medium; where the computer program includes program codes configured to perform the methods illustrated in the flowcharts. In such an embodiment, the computer program may be downloaded from online via a communication channel and installed, and/or installed from a detachable medium. When the computer program is executed by a central processing unit (CPU), the above functions defined in the methods according to the present disclosure are implemented. It should be noted that the computer-readable medium according to the present disclosure may be a computer-readable signal medium or a computer-readable storage medium or any combination thereof. The computer-readable medium may be, but not limited to, for example, electrical, magnetic, optical, electromagnetic, infrared or semiconductor systems, apparatuses or devices, or any combination thereof. More specific examples of the computer-readable storage medium may include, but not limited to: an electrical connection having one or more conducting wires, a portable computer magnetic disk, a hard disk, a random access memory (RAM), a read-only memory (ROM), an erasable programmable read-only memory (ERROM), an optical fiber, a portable compact disc read-only memory (CD-ROM or flash memory), an optical storage device, a magnetic storage device, or any combination thereof. In the present disclosure, the computer-readable storage medium may be any tangible medium including or storing a program. The program may be used by an instruction execution system, apparatus, device or any combination thereof. In the present disclosure, a computer-readable signal medium may include a data signal in the baseband or transmitted as a portion of a carrier wave, and the computer-readable signal medium bears computer-readable program code. Such a transmitted data signal may be, but not limited to, an electromagnetic signal, optical signal or any suitable combination thereof. The computer-readable signal medium may be any computer-readable medium in addition to the computer-readable storage medium. The computer-readable medium may send, spread or transmit the program which is used by the instruction execution system, apparatus, device or any combination thereof. The program code included in the computer-readable medium may be transmitted via any suitable medium, which includes, but is not limited to, wireless manner, electric wire, optical fiber, RF and the like, or any suitable combination thereof.

One or more programming languages or any combination thereof may be used to execute the computer program code operated in the present disclosure. The programming languages include object-oriented programming languages, for example, Java, Smalltalk and C++, and further include ordinary procedural programming languages, for example, C language or similar programming languages. The program code may be totally or partially executed by a user computer, or may be executed as an independent software package, or may be partially executed by a user computer and partially executed by a remote computer, or may be totally executed by the remote computer or a server. In the scenario involving a remote computer, the remote computer may be connected to the user computer via any type of network, including a local area network (LAN) or a wide area network (WAN), or may be connected to an external computer (for example, connecting to the external computer via the Internet provided by an Internet service provider).

The flowcharts and block diagrams in the accompanying drawings illustrate possibly practicable system architecture, functions and operations of the system, method and computer program product according to various embodiments of the present disclosure. In this sense, each block in the flowcharts or block diagrams may represent a module, a program segment or a portion of the code. The module, the program segment or the portion of the code includes one or more executable instructions for implementing specified logic functions. It should be noted that in some alternative implementations, the functions specified in the blocks may also be implemented in a sequence different from that illustrated in the accompanying drawings. For example, two continuous blocks may be practically performed substantially in parallel, and sometimes may be performed in a reverse sequence, which may depend on the functions involved. It should also be noted that each block in the block diagrams and/flowcharts and a combination of the blocks of the block diagrams and/or flowcharts may be implemented by using a dedicated hardware-based system for implementing the specified functions or operations, or may be implemented by using a combination of dedicated hardware and computer instructions.

The units involved in the embodiments of the present disclosure may be implemented by means of software or hardware. The described units may also be configured in a processor. The units may be described as follows. A processor includes a first acquiring unit, a second acquiring unit, a determining unit and a generating unit. In some scenarios the names of these units do not provide any limit the units. For instance, the determining unit may be described as “a unit for determining the profile information of the multimedia content that matches the feature informaiton”.

In another aspect, an embodiment of the present disclosure further provides a computer-readable medium in which a computer program is stored. The computer program implements the method as described in any one of the above embodiments when being executed by a processor.

In still another aspect, an embodiment of the present disclosure further provides a computer-readable medium. The computer-readable medium may be incorporated in the apparatus as described in the above embodiments, or may be arranged independently, not incorporated in the apparatus. One or more programs are stored in the computer-readable medium. When the one or more programs are executed by the apparatus, the apparatus is instructed to: acquire reading object data of multimedia content to be generated; parse the reading object data to acquire feature information of the reading object data; determine multimedia content profile information matching the feature information; and generate multimedia content corresponding to the reading object data according to the multimedia content profile information and the reading object data.

Described above are merely preferred exemplary embodiments of the present disclosure and illustration of the technical principle of the present disclosure. A person skilled in the art should understand that the scope of the present disclosure is not limited to the technical solution defined by a combination of the above technical features, and shall further cover the other technical solutions defined by any combination of the above technical features and equivalent features thereof without departing from the inventive concept of the present disclosure. For example, the scope of the present disclosure shall cover the technical solutions defined by interchanging between the above technical features and the technical features having similar functions disclosed (but not limited to those disclosed) in the present disclosure.

What is claimed is:

1. A method for generating multimedia content, comprising:
acquiring reading object data of multimedia content to be generated;
parsing the reading object data to acquire feature information of the reading object data;
determining multimedia content profile information matching the feature information; and
generating multimedia content corresponding to the reading object data according to the multimedia content profile information and the reading object data.

2. The method according to claim 1, wherein the multimedia content profile information comprises: feature information and editing information of photographed multimedia content.

3. The method according to claim 2, wherein the feature information of the multimedia content comprises at least one of: expression information, action information, script information, audio information, color information, and scenario information.

4. The method according to claim 2, wherein the editing information comprises: information of an application that generates the multimedia content.

5. The method according to claim 1, wherein the generating multimedia content corresponding to the reading object data according to the multimedia content profile information and the reading object data comprises:
acquiring multimedia content generation condition data corresponding to the multimedia content profile information from the reading object data; and
generating the multimedia content corresponding to the reading object data according to the multimedia content generation condition data and the multimedia content profile information.

6. The method according to claim 1, wherein
prior to the generating multimedia content corresponding to the reading object data according to the multimedia content profile information and the reading object data, the method further comprises: receiving an input multimedia content generation parameter; and
the generating multimedia content corresponding to the reading object data according to the multimedia content profile information and the reading object data comprises: generating the multimedia content corresponding to the reading object data according to the multimedia content profile information, the reading object data and the multimedia content generation parameter.

7. The method according to claim 1, further comprising:
displaying the multimedia content in a floating window; or
displaying the reading object data in a first region of a display screen, and displaying the generated multimedia content in a second region of the display screen.

8. The method according to claim 1, further comprising:
transmitting the generated multimedia content using a transmission protocol, wherein the transmission protocol carries the multimedia content profile information.

9. An apparatus for generating multimedia content, comprising:
a first acquiring module, configured to reading object data of multimedia content to be generated;
a second acquiring module, configured to parse the reading object data to acquire feature information of the reading object data;
a determining module, configured to determine multimedia content profile information matching the feature information; and
a generating module, configured to generate multimedia content corresponding to the reading object data according to the multimedia content profile information and the reading object data.

10. The apparatus according to claim 9, wherein the multimedia content profile information comprises: feature information and editing information of photographed multimedia content.

11. The apparatus according to claim 10, wherein the feature information of the multimedia content comprises at least one of: expression information, action information, script information, audio information, color information, and scenario information.

12. The apparatus according to claim 10, wherein the editing information comprises: information of an application that generates the multimedia content.

13. The apparatus according to claims 10, wherein the generating module is further configured to acquire multimedia content generation condition data corresponding to the multimedia content profile information from the reading object data; and generate the multimedia content corresponding to the reading object data according to the multimedia content generation condition data and the multimedia content profile information.

14. The apparatus according to claims 9, wherein
the apparatus further comprises: a receiving module, configured to receive a multimedia content generation parameter prior to generating multimedia content corresponding to the reading object data according to the multimedia content profile information and the reading object data; and
the generating module is further configured to generate the multimedia content corresponding to the reading object data according to the multimedia content profile information, the reading object data and the multimedia content generation parameter.

15. The apparatus according to claim 9, further comprising:
a display module, configured to display the multimedia content in a floating window; or configured to display the reading object data in a first region of a display screen, and display the generated multimedia content in a second region of the display screen.

16. The apparatus according to claim 9, further comprising:
a transmitting module, configured to transmit the generated multimedia content using a transmission protocol, wherein the transmission protocol carries the multimedia content profile information.

17. A device, comprising:
a non-transitory storage memory configured to store instructions; and
one or more processors in communication with the memory;
wherein the instructions, when being executed by the one or more processors, cause the one or more processors to:
acquire reading object data of multimedia content to be generated;
parse the reading object data to acquire feature information of the reading object data;
determine multimedia content profile information matching the feature information; and
generate multimedia content corresponding to the reading object data according to the multimedia content profile information and the reading object data.
